(19) United States
(12) Patent Application Publication
(10) Pub. No.: US 2017/0190835 A1
(43) Pub. Date: Jul. 6, 2017

(54) COPOLYMERS OF PEEK AND PEEK/PEK AND METHODS OF PREPARATION THEREOF

(71) Applicant: GHARDA CHEMICALS LIMITED, Maharashtra (IN)

(72) Inventors: Prakash D. TRIVEDI, Maharashtra (IN); Sanjay C. LIMAYE, Maharashtra (IN); Harishchandra P. NATU, Maharashtra (IN)

(21) Appl. No.: 15/462,617

(22) Filed: Mar. 17, 2017

Related U.S. Application Data
(63) Continuation of application No. PCT/IB2015/057120, filed on Sep. 16, 2015.

(30) Foreign Application Priority Data
Sep. 17, 2014 (IN) 2975/MUM/2014

(51) Int. Cl. C08G 65/40; C08G 75/23; C08G 81/00

(52) U.S. Cl. CPC C08G 65/4012; C08G 81/00; C08G 75/23; C08G 2650/40; C08G 2650/02

(57) ABSTRACT

Copolymers of PEEK and PEEK/PEK and methods of preparation thereof are provided. The melt temperatures of the PEEK copolymer and PEEK/PEK copolymer compositions are in the range of 350° C. to 420° C. The compositions are based on PEEK monomers biphenol and 4,4′-difluorobenzophenone with other PEEK co-monomers such as hydroquinone and PEK co-monomers such as 4-chloro-4′-hydroxybenzophenone, 4,4′-difluorobenzophenone and 4,4′-dihydroxybenzophenone.

### FIELD

The present disclosure relates to a polyether ether ketone (PEEK)/poly ether ketone (PEK) copolymer composition and a polyether ether ketone (PEEK) copolymer composition.

BACKGROUND

Polyether ether ketone (PEEK) and polyether ketone (PEK) are high performance plastics with high thermal resistance, which are used for a number of industrial applications. PEEK, which is synthesized from 4,4′-difluro benzophenone (DFB) and hydroquinone (HQ) monomers, has a glass transition temperature (T_{g}) of 143° C. and a melting point temperature (Tₘ) of 335° C. PEK, which is synthesized by self-condensation of 4-chloro 4′-hydroxybenzophenone (CHBP has glass transition temperature (T_{g}) of 153° C. and melting temperature (Tₘ) of 373° C. PEEK and PEK both show high thermal and chemical resistance and exhibit high mechanical strength, however, a further increase in thermal and chemical resistance is required for use in different industries. A Polyether ketone ketone (PEKK) synthesized from p-terephthaloyl chloride and diphenyl ether results in higher T_{g} and Tₘ, but has a lower thermal stability and hence, it is difficult to process like a thennoplastic. Commercially available PEKKs have lower T_{g} and Tₘ due to the addition of a third monomer ‘isophthaloyl chloride’ resulting in reduced crystallinity and solvent resistance; and hence, restricts the use of such PEKKs in high temperature applications.

PEEK synthesized from DFB and biphenol has a superior T_{g} and Tₘ and chemical resistance. PEEK synthesized from DFB and biphenol has Tₘ around 420° C. PEEK with such high Tₘ necessitates still higher processing temperature of around 450° C., which tends to degrade or cross-link under high shear and temperature conditions.

Therefore, there is a need for PEEK and PEK having high thermal and chemical resistance, which can still be readily processed.

### OBJECTS

Some of the objects of the present disclosure, which at least one embodiment herein satisfies, are as follows:

An object of the present disclosure is to provide PEEK and PEK copolymers having high thermal and chemical resistance.

Another object of the present disclosure is to provide PEEK and PEK copolymers having high thermal and chemical resistance which are also readily processible.

Still another object of the present disclosure is to provide a process for the preparation of copolymers of PEEK and PEK with high T_{g} and Tₘ.

Other objects and advantages of the present disclosure will be more apparent from the following description which is not intended to limit the scope of the present disclosure.

### SUMMARY

The present disclosure provides a PEEK copolymer composition and a PEEK/PEK copolymer composition having a high T_{g} and Tₘ. The melt temperatures of the PEEK copolymer composition and the PEEK/PEK copolymer composition of the present disclosure are in the range of 350° C. to 420° C.

The PEEK copolymer composition can be prepared by reacting at least one monomer selected from the group consisting of 4,4′-difluorobenzophenone and derivatives of 4,4′-difluorobenzophenone with:
(i) at least one monomer selected from the group consisting of biphenol and derivatives of biphenol; and
(ii) at least one monomer selected from the group consisting hydroquinone and derivatives of hydroquinone.

In an embodiment, the resultant PEEK copolymer composition obtained comprises the subunits of:

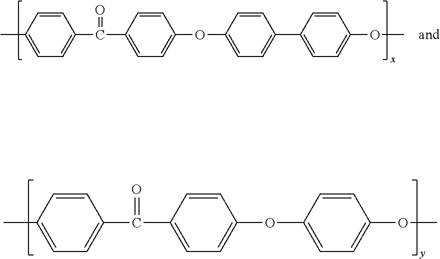

wherein x and y vary from 5 to 95 mole % and (x+y) equals 100 mole %.

The PEEK/PEK copolymer composition as a block copolymer can be prepared by one of the following methods:
(a) preparing a copolymer of PEEK and reacting with the monomer(s) of PEK;
(b) preparing a copolymer of PEK and reacting with the monomers of PEEK; and
(c) preparing the copolymers of PEEK and PEK and then reacting the copolymers with each other.

The PEEK/PEK copolymer composition can be prepared by reacting the monomers of the PEEK component and the monomers of PEK component together.

In another embodiment, the PEEK/PEK copolymer composition comprises:
A) a PEEK component comprising the subunit of

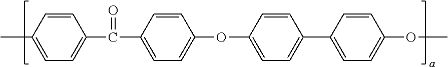

and optionally, an additional subunit of

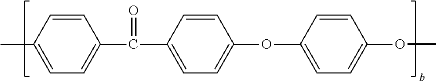

and
B) a PEK component comprising at least one subunit selected from the group consisting of:

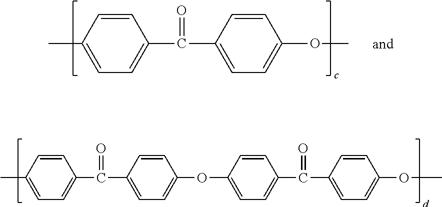

wherein a, c and d in the PEEK/PEK copolymer composition vary from 5 to 95 mole % and b in the PEEK/PEK copolymer composition varies from 95 to 5 mole %.

Typically, the PEEK copolymer composition and the PEEK/PEK copolymer composition are block or random copolymers.

### BRIEF DESCRIPTION OF ACCOMPANYING DRAWINGS

The present disclosure will now be described with the help of the accompanying drawings in which:

FIG. 1 illustrates a DMA curve for a PEEK/PEK block copolymer synthesized in Experiment 13 in accordance with the present disclosure.

FIG. 2 illustrates a DMA curve for a PEEK/PEK block copolymer synthesized in Experiment 14 in accordance with the present disclosure.

### DETAILED DESCRIPTION

The disclosure will now be described with reference to the accompanying embodiments which do not limit the scope and ambit of the disclosure. The description provided is purely by way of Experiment and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The Experiments used herein are intended merely to facilitate an understanding of ways in which the embodiments herein may be practiced and to further enable those of skill in the art to practice the embodiments herein. Accordingly, the Experiments should not be construed as limiting the scope of the embodiments herein.

In accordance with one aspect of the present disclosure, there is provided a PEEK copolymer composition having high glass transition temperature (T_{g}) and melting point temperature (Tₘ). The PEEK copolymer composition as prepared by the process of the present disclosure is readily processible and thermally stable.

The PEEK copolymer composition is prepared by reacting at least one monomer selected from the group consisting 4,4′-difluorobenzophenone and derivatives of 4,4′-difluorobenzophenone with:
(i) at least one monomer selected from the group consisting of biphenol and derivatives of biphenol; and
(ii) at least one monomer selected from the group consisting hydroquinone and derivatives of hydroquinone.

The melt temperature of the PEEK copolymer composition of the present disclosure is in the range of 350° C. to 420° C.

In an exemplary embodiment, the PEEK copolymer is prepared by reacting 4,4′-difluorobenzophenone with biphenol and hydroquinone. The resultant PEEK copolymer composition obtained comprises the subunits of:

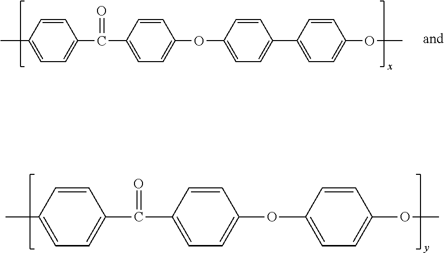

wherein x and y vary from 5 to 95 mole % and (x+y) equals 100 mole %.

The PEEK copolymer composition of the present disclosure can be a block copolymer or a random copolymer.

In an embodiment of the present disclosure, a process for preparing a block copolymer of PEEK of the present disclosure comprises the following steps:
(a) reacting at least one monomer selected from the group consisting of biphenol and derivatives of biphenol with at least one monomer selected from the group consisting 4,4′-difluorobenzophenone and derivatives of 4,4′-difluorobenzophenone to obtain a first copolymer of PEEK having a molecular weight in the range of 2000 to 20000 Daltons;
(b) reacting at least one monomer selected from the group consisting of hydroquinone and derivatives of hydroquinone with at least one monomer selected from the group consisting 4,4′-difluorobenzophenone and derivatives of 4,4′-difluorobenzophenone to obtain a second copolymer of PEEK having a molecular weight in the range of 2,000 to 20,000 Daltons; and
(c) reacting the first copolymer of PEEK with the second copolymer of PEEK to obtain the block copolymer of PEEK.

The block copolymer of the PEEK copolymer composition of the present disclosure has a molecular weight in the range of 30,000 to 2,00,000 Daltons.

In an another embodiment, a process for preparing a random copolymer of the PEEK copolymer composition of the present disclosure comprises reacting at least one monomer selected from the group consisting of biphenol and derivatives of biphenol, at least one monomer selected from the group consisting of hydroquinone and derivatives of hydroquinone and at least one monomer selected from the group consisting of 4,4′-difluorobenzophenone and derivatives of 4,4′-difluorobenzophenone together to obtain the random copolymer. The random copolymer of the PEEK copolymer composition of the present disclosure has a molecular weight in the range of 30,000 to 2,00,000 Daltons.

In accordance with another aspect of the present disclosure, there is provided a PEEK/PEK copolymer composition comprising:
a. a PEEK copolymer prepared by reacting at least one monomer selected from the group consisting of 4,4′-difluorobenzophenone and derivatives of 4,4′-difluorobenzophenone with
   i. at least one monomer selected from the group consisting of biphenol and derivatives of biphenol;
   ii. optionally, at least one monomer selected from hydroquinone and derivatives of hydroquinone; and
b. a PEK copolymer prepared by condensing at least one monomer selected from the group consisting of 4-chloro-4′-hydroxybenzophenone and derivatives of 4-chloro-4′-hydroxybenzophenone; or reacting at least one monomer selected from the group consisting of 4,4′-difluorobenzophenone and derivatives of 4,4′-difluorobenzophenone with at least one monomer selected from the group consisting of 4,4′-dihydroxybenzophenone and its derivatives.

The ratio of PEEK:PEK is in the range from 5:95 mole % to 95:5 mole %.

The melt temperature of the PEEK/PEK copolymer composition of the present disclosure is in the range of from 350° C. to 420° C.

In an exemplary embodiment, the PEEK/PEK copolymer composition comprises:
a) a PEEK component comprising the subunit of

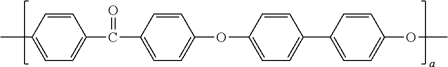

and optionally, an additional subunit of

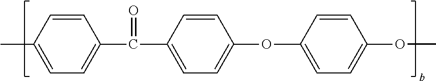

and

b) a PEK component comprising at least one subunit selected from the group consisting of:

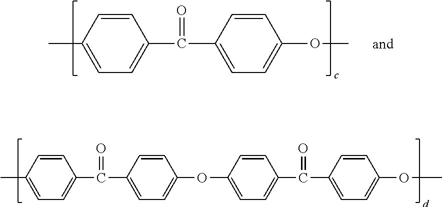

wherein ‘a’, ‘c’ and ‘d’ in the PEEK/PEK copolymer composition is in the range of 5 to 95 mole % and ‘b’ in the PEEK/PEK copolymer composition is in the range of 95 to 5 mole %.

The PEEK/PEK copolymer composition of the present disclosure can be a block copolymer or a random copolymer.

In one embodiment, a process for preparing a block copolymer of PEEK/PEK copolymer composition of the present disclosure comprises the following steps:
(a) reacting at least one monomer selected from the group consisting of biphenol and derivatives of biphenol with at least one monomer selected from the group consisting of 4,4′-difluorobenzophenone and derivatives of 4,4′-difluorobenzophenone; or reacting at least one monomer selected from the group consisting of biphenol and derivatives of biphenol, at least one monomer selected from the group consisting of hydroquinone and derivatives of hydroquinone with at least one monomer selected from the group consisting of 4,4′-difluorobenzophenone and derivatives of 4,4′-difluorobenzophenone to obtain a copolymer of PEEK having a molecular weight in the range of 2000 to 20000 Daltons;
(b) condensing at least one monomer selected from the group consisting of 4-chloro-4′-hydroxybenzophenone and derivatives of 4-chloro-4′-hydroxybenzophenone; or reacting at least one monomer selected from the group consisting of 4,4′-difluorobenzophenone and derivatives of 4,4′-difluorobenzophenone with at least one monomer selected from the group consisting of 4,4′-dihydroxybenzophenone and its derivatives to obtain a copolymer of PEK having a molecular weight in the range of 2,000 to 20,000 Daltons; and
(c) reacting copolymers of PEEK and PEK to obtain the block copolymer of PEEK/PEK copolymer composition having a molecular weight in the range of 30,000 to 2,00,000 Daltons.

In an another embodiment, the process for preparing a block copolymer of PEEK/PEK copolymer composition of the present disclosure comprises the following steps:
(a) reacting at least one monomer selected from the group consisting of biphenol and derivatives of biphenol with at least one monomer selected from the group consisting of 4,4′-difluorobenzophenone and derivatives of 4,4′-difluorobenzophenone; or at least one monomer selected from the group consisting of biphenol and derivatives of biphenol, at least one monomer selected from the group consisting of hydroquinone and derivatives of hydroquinone with at least one monomer selected from the group consisting of 4,4′-difluorobenzophenone and derivatives of 4,4′-difluorobenzophenone to obtain a copolymer of PEEK having a molecular weight in the range of 2,000 to 20,000 Daltons; and
(b) reacting at least one monomer selected from the group consisting of 4-chloro-4′-hydroxybenzophenone and derivatives of 4-chloro-4′-hydroxybenzophenone with the copolymer of PEEK to obtain the block copolymer of PEEK/PEK copolymer composition having a molecular weight in the range of 30,000 to 2,00,000 Daltons.

In a yet another embodiment, the process for preparing a block copolymer of PEEK/PEK copolymer composition of the present disclosure comprises the following steps:
(a) condensing at least one monomer selected from the group consisting of 4-chloro-4′-hydroxybenzophenone and derivatives of 4-chloro-4′-hydroxybenzophenone; or reacting at least one monomer selected from the group consisting of 4,4′-difluorobenzophenone and derivatives of 4,4′-difluorobenzophenone with at least one monomer selected from the group consisting of 4,4′-dihydroxybenzophenone and its derivatives to obtain a copolymer of PEK having a molecular weight in the range of 2,000 to 20,000 Daltons; and
(b) reacting at least one monomer selected from the group consisting of biphenol and derivatives of biphenol with at least one monomer selected from the group consisting of 4,4′-difluorobenzophenone and derivatives of 4,4′-difluorobenzophenone; or at least one monomer selected from the group consisting of biphenol and derivatives of biphenol, at least one monomer selected from the group consisting of hydroquinone and derivatives of hydroquinone and at least one monomer selected from the group consisting of 4,4′-difluorobenzophenone and derivatives of 4,4′-difluorobenzophenone with the copolymer of PEK to obtain the block copolymer of PEEK/PEK copolymer composition having a molecular weight in the range of 30,000 to 2,00,000.

In a further embodiment, a process for preparing a random copolymer of PEEK/PEK copolymer composition of the present disclosure comprises one of the following methods:
reacting at least one monomer selected from the group consisting of biphenol and derivatives of biphenol, at least one monomer selected from the group consisting of 4,4′-difluorobenzophenone and derivatives of 4,4′-difluorobenzophenone with at least one monomer selected from the group consisting of 4-chloro-4′-hydroxybenzophenone and derivatives of 4-chloro-4′-hydroxybenzophenone;
reacting at least one monomer selected from the group consisting of biphenol and derivatives of biphenol, at least one monomer selected from the group consisting of hydroquinone and derivatives of hydroquinone at least one monomer selected from the group consisting of 4,4′-difluorobenzophenone and derivatives of 4,4′-difluorobenzophenone with at least one monomer selected from the group consisting of 4-chloro-4′-hydroxybenzophenone and derivatives of 4-chloro-4′-hydroxybenzophenone;
reacting at least one monomer selected from the group consisting of biphenol and derivatives of biphenol, at least one monomer selected from the group consisting of 4,4′-difluorobenzophenone and derivatives of 4,4′-difluorobenzophenone with at least one monomer selected from the group consisting of 4,4′-dihydroxybenzophenone and its derivatives; and
reacting at least one monomer selected from the group consisting of biphenol and derivatives of biphenol, at least one monomer selected from the group consisting of hydroquinone and derivatives of hydroquinone, at least one monomer selected from the group consisting of 4,4′-difluorobenzophenone and derivatives of 4,4′-difluorobenzophenone with at least one monomer selected from the group consisting of 4,4′-dihydroxybenzophenone and its derivatives

to obtain the random copolymer of PEEK/PEK copolymer composition having a molecular weight in the range of 30,000 to 2,00,000.

Non-limiting examples of derivatives of biphenol include an alkyl substituted (at the aromatic ring) 4,4′-biphenol, an aryl substituted (at the aromatic ring) 4,4′-biphenol. In accordance with an exemplary embodiment of the present disclosure, the derivative of biphenol are alkali salts of alkyl/aryl substituted biphenols and/or alkali salts of unsubstituted biphenols. The alkali salt is a salt of at least one alkali metal selected from the group consisting of lithium, sodium and potassium. In an exemplary embodiment, the alkali metal is sodium.

Non-limiting examples of derivatives of hydroquinones include an alkyl substituted (at the aromatic ring) hydroquinone and an aryl substituted (at the aromatic ring) hydroquinone. In accordance with an exemplary embodiment of the present disclosure, derivatives of hydroquinones are alkali salts of alkyl/aryl substituted hydroquinone and/or alkali salts of unsubstituted hydroquinone. The alkali salt is a salt of at least one alkali metal selected from the group consisting of lithium, sodium and potassium. In an exemplary embodiment, the alkali metal is sodium.

Non-limiting examples of derivatives of 4,4′-difluorobenzophenone include an alkyl substituted (at the aromatic ring) 4,4′-difluorobenzophenone and an aryl substituted (at the aromatic ring) 4,4′-difluorobenzophenone.

Non-limiting examples of derivatives of 4-chloro-4′-hydroxybenzophenone include an alkyl substituted (at the aromatic ring) 4-chloro-4′-hydroxybenzophenone and an aryl substituted (at the aromatic ring) 4-chloro-4′-hydroxybenzophenone. In accordance with an exemplary embodiment of the present disclosure, derivatives of 4-chloro-4′-hydroxybenzophenone are alkali salts of unsubstituted or substituted 4-chloro-4′-hydroxybenzophenone. The alkali salt is a salt of at least one alkali metal selected from the group consisting of lithium, sodium and potassium. In an exemplary embodiment, the alkali metal is sodium.

Non-limiting examples of derivatives of 4,4′-dihydroxybenzophenone include an alkyl substituted (at the aromatic ring) 4,4’-dihydroxybenzophenone and an aryl substituted (at the aromatic ring) 4,4′-dihydroxybenzophenone. In accordance with an exemplary embodiment of the present disclosure, derivatives of 4,4′-dihydroxybenzophenone are salkali salts of unsubstituted or substituted 4,4′-dihydroxybenzophenone. The alkali salt is a salt of at least one alkali metal selected from the group consisting of lithium, sodium and potassium. In an exemplary embodiment, the alkali metal is sodium.

In accordance with the present disclosure, the ratio of the PEEK component to the PEK component in the block copolymer ranges from 5:95 mole % to 95:5 mole %. Similarly, the ratio of the PEEK component to the PEK component in the random copolymer ranges from 95:5 to 5:95 mole %.

In an exemplary embodiment of the present disclosure, the alkali of alkali salt of unsubstituted or substituted biphenol, alkali salt of unsubstituted or substituted 4,4′-dihydroxybenzophenone and alkali salt of unsubstituted or substituted 4-chloro-4′-hydroxybenzophenone is sodium.

The copolymers synthesized according to the present disclosure have higher T_{g} and Tₘ as compared to the traditional hydroquinone/4,4′-difluorobenzophenone based PEEK, however, the Tₘ is lower as compared to biphenol/4,4′-difluorobenzophenone based PEEK.

The present disclosure is further described in light of the following laboratory experiments which are set forth for illustration purpose only and not to be construed for limiting the scope of the disclosure. The following laboratory scale experiments can be scaled up to industrial/commercial scale:

Experiments

Experiment 1: Preparation of Copolymer with PEEK/PEK of 50:50

1A: Preparation of Copolymer of PEK

A reactor containing inlets for reactants, nitrogen gas and stirrer, was flushed with nitrogen gas. The reactor was charged with 254.63 g of Na salt of 4-chloro-4′-hydroxybenzophenone, 2.1227 g of K₃PO₄, 1.06 g of Na₂CO₃ and 600 g of diphenyl sulfone (DPSO₂). The reactants were heated to 150° C., and the temperature was raised to 270° C. after 1.5 hours. The reaction was maintained at 270° C. for 2 hours, which was further gradually increased from 270° C. to 315° C. over a period of 1.5 hours and maintained at 315° C. for 15 minutes to obtain a copolymer mass. The copolymer mass obtained was cooled and removed from the reaction mixture and crushed. DPSO₂ and Na salt were removed with iterated washings with toluene and water and the pre-polymerized mass was dried.

86 g of the copolymer was obtained and was stored under nitrogen until further use.

The inherent viscosity of the copolymer sample in 98% H₂SO₄ was 0.53 dl/g, indicating the copolymer synthesized as a low molecular weight oligomer when compared with commercial PEK having an inherent viscosity of 0.80 to 1.2 dl/g.

1B: Preparation of Sodium Salt of Biphenol

1 mole (186 g) of the purified 4,4′-biphenol was added to 1980 mL of 1 N methanolic NaOH in a Hastelloy reactor which was made oxygen free. Na₂CO₃ (1.06 g) was added to the reaction mixture and stirred for 30 minutes and concentrated to get sodium salt. The sample was dried under vacuum at 80° C.

1C: Preparation of Block Copolymer of PEEK/PEK

32.01 g of sodium salt of biphenol (purity 88.37%), 27.08 g of 4,4′-difluorobenzophenone, 0.522 g of K₃PO₄, 147.6 g of DPSO₂, 1.903 g of Na₂CO₃ were charged into the reactor under oxygen free condition by passing nitrogen gas.

The reaction mixture was heated to 170° C. in 1.5 hour, with stirring at a speed of 200 rpm and rate of flow of nitrogen gas was maintained at 20 lit/hour. The reaction was maintained at 170° C. for 1 hour. After that the reaction mixture was further heated to 200° C. for 1 hour. In the next step, the reaction mixture was heated to 250° C. in 1 hour. 152 g of PEK and 42 gm PEEK were added to the reaction mixture by maintaining the temperature at 250° C. for 40 min. The temperature was increased to 270° C. over a period of 15 min and the reaction mass was maintained at 270° C. for 2 hour, to remove water.

Further, the reaction mixture was heated to 315° C. over a period of 1.5 hour. 0.35 g of fluoro benzophenone, used as end capping agent along with 70 g DPSO₂ was added after maintaining the reaction mixture at 315° C. for 25 minutes. The end capping reaction was carried out at 315° C. for 30 minutes. After the reaction was completed, the polymer was precipitated in toluene, filtered and further washed with toluene and water several times to get rid of DPSO₂ and salt and was subsequently dried.

The Inherent Viscosity in 98% H₂SO₄ at 25° C. was 1.37 dl/g. Differential Scaning Colorimetry of the final sample has a Tₘ of 352° C. and T_{g} 163° C.

Experiment 2: Preparation of Polymer with PEEK/PEK of 30:70

2A: Preparation of Copolymer

PEK copolymer was prepared as per experiment 1A and kept aside under nitrogen till further use.

2B: Preparation of Sodium Salt of Biphenol

Sodium salt of Biphenol was Prepared as Per experiment 1B.

2C: Preparation of Block Copolymer of PEEK/PEK

The reactor was charged with 14.95 g of sodium salt of biphenol as prepared in experiment 1B, 14.3117 g of 4,4′-difluorobenzophenone, 0.2760 g of K₃PO₄, 78 g of DPSO2 and 0.3445 g of Na₂CO₃ under nitrogen gas and was heated to 170° C. for 30 min. The reaction mixture was maintained at 170° C. for 1 hour. The temperature was increased to 200° C. over a period of 1 hour and maintained at 200° C. for 1 hour. Further, the reaction mixture was heated to 250° C. over a period of 1 hour. 92.9322 g of PEK reaction mass from experiment 1 was added over a period of 40 minutes by maintaining temperature at 250° C. The reaction mixture was heated to 270° C. and maintained at that temperature for 2 hour to remove water. The reaction mixture mass was then heated to 315° C. for a period of 1.5 hour. The reaction mixture was maintained at 315° C. for 180 min. The end-capping agent of 0.35 g Fluoro-Benzophenone along with 70 g of DPSO₂ was added and reaction mass was maintained at 315° C. for 30 mins.

The reaction mixture was removed and treated with toluene and water as per experiment 1C. The dried block copolymer had DSC Tₘ 360° C. and T_{g} 159° C. Its Gel Permeation Chromatography (GPC) molecular weight as determined for the soluble part were Number Average Molecular Weight (Mₙ) and Weight Average Molecular Weight M_{w}. Inherent Viscosity as determined using 0.2% weight of polymer in 100 ml H₂SO₄ (98%) was 0.99 dl/g.

The dried powder was compression molded in a press using a tube mold giving tube of Outer Diameter 50 mm, and Inner Diameter 39.5 mm and height of 37.5 mm. The molding was carried out at 400° C., 2000 psi pressure for 60 minutes. The molded article was machined and used as a ring or gasket or seal in oil industries.

Experiment 3 to 8: Preparation of PEEK/PEK Block Copolymer

The copolymer of 4-chloro-4′-hydroxybenzophenone was prepared as per experiment 1A, and Na salt of biphenol was prepared as per experiment 1B and the Block copolymers were prepared using different weight proportions of CHBP copolymer and PEEK monomers in ratios as given in Table 1. The polymerization was completed as per experiment 1C, end capping was carried out and the polymer was washed with giving toluene and water, dried and tested for Inherent Viscosity, Gel Permeation Chromatography (GPC) molecular weights and DSC T_{g} and Tₘ.

The results obtained are depicted in Table 1.

Experiment 9:

In this experiment, 100% Biphenol based PEEK was polymerized with Biphenol and 4,4′-difluorobenzophenone using 1.15 g of Na₂CO₃. In a 1-lit Hastelloy reactor, 180 g of DPSO₂, 27.1 g of biphenol, 18.3gm of Na₂CO₃, 0.6368 g of K₃PO₄, wer charged under nitrogen gas to make the reactor free of oxygen. The reaction mass was heated to 170° C. over a period of 1 hour, and maintained for additional 1 hour, then heated to 200° C. over a period of 1 hour and maintained at 200° C. for another 1 hour. The reaction mass was further heated to 270° C. over a period of 1.5 hour and maintained at 270° C. for 2 hour, to ensure complete water removal. It was then cooled to 250° C., and 33.027 g of 4,4′-difluorobenzophenone was added and the reaction mass was heated to 270° C. over a period of 30 min and maintained at 270° C. for 30 min. Then it was heated to 315° C. over a period of 1.5 hour, while stirring. The reaction mass was maintained at 315° C. for 2 hour. The polymer was end-capped using 0.3 g of fluorobenzophenone (FBP) in 70 g of DPSO₂. Polymer so produced was further treated as described in experiment 1C. The dried Biphenol based PEEK was found to have an Inherent Viscosity of 0.33 dL/g and DSC T_{g} 168° C. and Tₙ, 420° C.

Experiment 10:

In this experiment, a 1-lit Hastelloy reactor was made oxygen free by passing nitrogen gas and the following reactants were charged: 89.11 g of sodium salt of CHBP, 210 g of DPSO₂, 0.7429 g of K₃PO₄. The reactor was made oxygen free and the reaction mixture was heated to 150° C. and then to 270° C. over a period of 1.5 hour. The reaction mixture was maintained at 270° C. for 2 hour. Further, the reaction mixture was heated to 315° C. in 1.5 hour and simultaneously the speed of rotation was increased to 350 rpm after the temperature reached 300° C. The sample was removed after maintaining the reaction mixture at 315° C. for 3.5 hour. The treated and dried copolymer sample had an Inherent Viscosity of 1.2 dL/g and T_{g} and Tₘ of 154° C. and 372° C. respectively.

TABLE 1
PEEK/PEK Block Copolymers, Molecular
Weight and DSC Melting Point

| | Inherent | Gel Permeation | | | | |
|---|---|---|---|---|---|---|
| Ratio of | Viscosity | Chromatography (GPC) | | | DSC | |
| PEEK/PEK | dL/g | M_{w} | Mₙ | M_{w}D | T_{g} | Tₘ |
| 100:0 | — | No | — | — | 168 | 420 |
| (Experiment #9) | | dissolution | | | | |
| | | in PCP | | | | |
| 90:10 | 0.74 | No | — | — | 167 | 420 |
| (Experiment#3) | | dissolution | | | | |
| | | in PCP | | | | |
| 70:30 | 0.47 | 61050 | 16085 | 3.79 | 162 | 408 |
| (Experiment#4) | | | | | | |
| 50:50 | 1.37 | 104280 | 17270 | 6.03 | 163 | 352 |
| (Experiment#1) | | | | | | |
| 40:60 | 0.82 | 58271 | 14700 | 3.96 | 159 | 363 |
| (Experiment#5) | | | | | | |
| 30:70 | 0.82 | 76180 | 29000 | 2.62 | 159 | 358 |
| (Experiment#6) | | | | | | |
| 30:70 | 0.99 | 94000 | 20560 | 4.5 | 159 | 360 |
| (Experiment#2) | | | | | | |
| 20:80 | 0.95 | 91910 | 19210 | 4.78 | 159 | 364 |
| (Experiment#7) | | | | | | |
| 10:90 | 0.19 | 65490 | 19000 | 3.43 | 158 | 369 |
| (Experiment#8) | | | | | | |
| 0:100 | 1.2 | 110000 | 28000 | 3.92 | 154 | 372 |
| (Experiment#10) | | | | | | |

Table 1 demonstrates the easy processibility of the copolymers, as the DSC of most of the copolymers of the present disclosure show less than 410° C., which is desired. Tₘ of less than 410° C. indicate that the copolymers of the present disclosure are thermally stable at their processing temperature of 420° C. as compared to PEEK based on Biphenol with Tₘ of 420° C. (Experiment 9), which is more difficult to process and will be less thermally stable under high shear and heat.

Experiment 11: Preparation of PEEK/PEK Random Copolymer

A random copolymer of PEK and PEEK was prepared by adding 4,4′-difluorobenzophenone to Sodium salt of Biphenol and CHBP, prepared in the weight ratio of 70:30 at 250° C. and completing polymerization to get the random copolymer.

12.09 g of purified Biphenol, 0.8809 g of K₃PO₄, 249 g of DPSO2, 25.2943 g of Na₂CO₃ and 66.291 g of CHBP under nitrogen was charged into an oxygen free reactor. The reaction mass was then heated to 170° C. over a period of 1.0 hour, with stirring at 200 rpm, and maintained for 1 hour. The reaction mass was heated to 200° C. over a period of 0.5 hour and maintained at 200° C. for another 0.5 hour. The reaction mass was further heated to 270° C. over a period of 1 hour. and maintained at 270° C. for 2 hour and cooled to 250° C. 14.3117 g of 4,4′-difluorobenzophenone was added along with 15 g of DPSO₂ at 250° C. over a period of 5 min. Then the reaction mass was heated to 270° C. over a period of 15min and maintained for another 1 hour. The reaction mass was further heated to 315° C. for 1.5 hour, and maintained at 315° C. for 30 min. A sample (Sample 1) was removed and end-capping agent 0.35 g FBP along with 70 g DPSO₂ were added to reaction mass and maintained at 315° C. for another 30 min. The reaction mass was then cooled and treated with toluene and water to remove DPSO₂ and salt and the polymer obtained was dried at 150° C. till a constant weight was achieved.

DSC of the random copolymer obtained showed that the random copolymer had a Tₘ of 330° C. and a T_{g} of 160° C.

Experiment 12: Preparation of PEEK/PEK Random Copolymer

The Experiment 11 was repeated to give a random PEEK/PEK copolymer again. DSC of sample shows a Tₘ of 321° C. and T_{g} of 153° C., similar to that obtained in Experiment 11. The results are depicted in Table 2.

TABLE 2
Results of PEEK/PEK Random Copolymers obtained
in Experiment 11 and Experiment 12

| | | | | T_{g} | Tₘ |
|---|---|---|---|---|---|
| Sample Description | M_{w} | Mₙ | M_{w}D | (° C.) | (° C.) |
| Experiment 11 | 200220 | 42390 | 4.72 | 160 | 330 |
| Experiment 12 | 118700 | 34156 | 3.47 | 153 | 321 |

Experiments 13 and 14: Extrusion and Injection Molding of PEEK/PEK Copolymer Compositions

In this Experiment, two batches of PEEK/PEK block copolymers were prepared using 30:70 weight ratio to give an Inherent Viscosity of 0.99 dL/g and these were separately mixed with 0.2% anti-oxidant and extruded on Dynisco LME (Lab mixing extruder) by adding at 400° C. These were molded on BOY's Injection molding machine keeping at a temperature of 410° C. and a Mold temperature of 190° C. The molded sample was used for impact testing and measuring melt viscosity using Anton Paar viscometer at a shear rate range of 0-100 radian at 410° C.

TABLE 3
Impact testing of PEEK:PEK (30:70) Block copolymers.

| | Inherent Viscosity | Impact strength |
|---|---|---|
| Sample Description | dL/g | (notched) J/m |
| Experiment 13 | 0.82 | 17 |
| Experiment 14 | 0.99 | 50 |

The ready extrusion and injection molding of the compositions of the present disclosure suggest that the copolymers are easily processible at temperatures of 410° C., unlike 100% Biphenol based PEEK prepared as in Experiment 9.

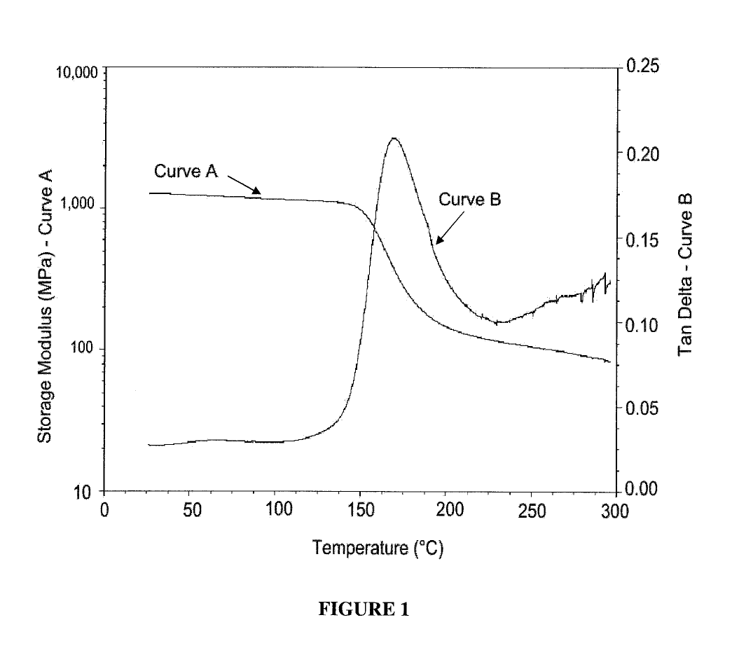

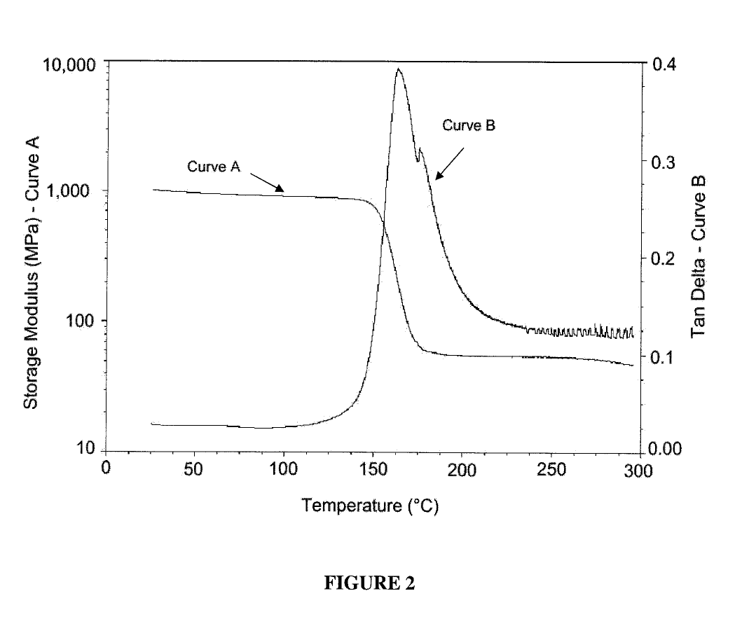

Further FIGS. 1 and 2 demostrate that there is a single peak signifying the presence of a copolymer of PEEK and PEK and that the polymeric material is not a blend of PEEK and PEK.

### TECHNICAL ADVANCES AND ECONOMICAL SIGNIFICANCE

The present disclosure described herein above has several technical advantages including, but not limited to, the realization of:
PEEK and PEK copolymers having high temperature and chemical resistance which are also readily processible and thermally stable; and
PEEK and PEK copolymers with high T_{g} and Tₘ.

The description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A PEEK copolymer composition prepared by reacting at least one monomer selected from the group consisting of 4,4′-difluorobenzophenone and derivatives of 4,4′-difluorobenzophenone with
(i) at least one monomer selected from the group consisting of biphenol and derivatives of biphenol; and
(ii) at least one monomer selected from the group consisting of hydroquinone and derivatives of hydroquinone;
wherein the melt temperature of the PEEK copolymer composition is in the range of 350° C. to 420° C.

2. The PEEK copolymer composition as claimed in claim 1 comprising the sub-units of: 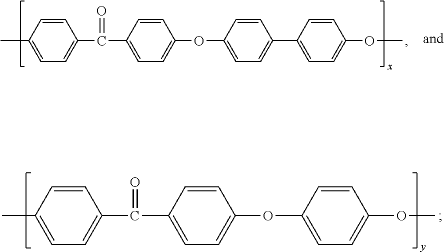
wherein x and y vary in the range of 5 to 95 mole %.

3.-10. (canceled)

11. The PEEK copolymer composition as claimed in claim 1, wherein said PEEK copolymer composition is a block copolymer.

12. The PEEK copolymer composition as claimed in claim 1, wherein said PEEK copolymer composition is a random copolymer.

13. A process for preparation of PEEK block copolymer as claimed in claim 11, said process comprising the following steps:
(a) reacting at least one monomer selected from the group consisting of biphenol and derivatives of biphenol and at least one monomer selected from the group consisting of 4,4′-difluorobenzophenone and derivatives of 4,4′-difluorobenzophenone to obtain a first copolymer of PEEK having a molecular weight in the range of 2000 to 20000 Daltons;
(b) reacting at least one monomer selected from the group consisting of hydroquinone and derivatives of hydroquinone with at least one monomer selected from the group consisting of 4,4′-difluorobenzophenone and derivatives of 4,4′-difluorobenzophenone to obtain a second copolymer of PEEK having a molecular weight in the range of 2000 to 20000 Daltons; and
(c) reacting said first copolymer of PEEK and said second copolymer of PEEK to obtain the block copolymer having a molecular weight in the range of 30,000 to 2,00,000 Daltons.

14. The process for preparation of PEEK random copolymer as claimed in claim 12, said process comprising reacting biphenol and derivatives of biphenol, hydroquinone and derivatives of hydroquinone and 4,4′-difluorobenzophenone and derivatives of 4,4′-difluorobenzophenone to obtain the random copolymer having a molecular weight in the range of 30,000 to 2,00,000 Daltons.

15. A PEEK/PEK copolymer composition comprising:
a. A PEEK copolymer in accordance with claim 11 prepared in accordance with claim 13; bonded with
b. a PEK copolymer prepared by condensing at least one monomer selected from the group consisting of 4-chloro-4′-hydroxybenzophenone and derivatives of 4-chloro-4′-hydroxybenzophenone; or reacting at least one monomer selected from the group consisting of 4,4′-difluorobenzophenone and derivatives of 4,4′-difluorobenzophenone with at least one monomer selected from the group consisting of 4,4′-dihydroxybenzophenone and derivatives of 4,4′-dihydroxybenzophenone;
wherein the ratio of PEEK:PEK is in the range of 5:95 mole% to 95:5 mole % and melting temperature of said PEEK/PEK copolymer composition is in the range of 350° C. to 420° C.

16. The PEEK/PEK copolymer composition as claimed in claim 15 comprising:
i. a PEEK component comprising the subunit of 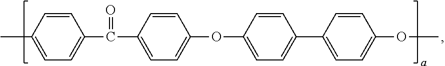
and
optionally, a subunit of 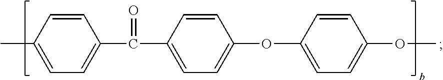
and
ii. a PEK component comprising at least one subunit selected from the group consisting of 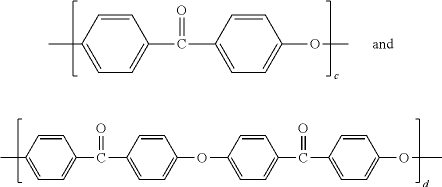
wherein ‘a’, ‘c’ and ‘d’ in said copolymer composition are in the range of 5 to 95 mole%, ‘b’ in said copolymer composition is in the range of 95 to 5 mole %.

17. The PEEK/PEK copolymer composition as claimed in claim 15, wherein said PEEK/PEK copolymer is a block copolymer.

18. The PEEK/PEK copolymer composition as claimed in claim 15, wherein said PEEK/PEK copolymer is a random copolymer.

19. A process for preparing PEEK/PEK block copolymer, said process comprising adopting a sequence of steps selected from the following sequences consisting of:
Sequence I.
a. reacting at least one monomer selected from the group consisting of 4,4′-difluorobenzophenone and derivatives of 4,4′-difluorobenzophenone with
i. at least one monomer selected from the group consisting of biphenol and derivatives of biphenol; and
ii. optionally, at least one monomer selected from the group consisting of hydroquinone and derivatives of hydroquinone,
to obtain a copolymer of said PEEK having a molecular weight in the range of 2000 to 20000 Daltons;
b. condensing at least one monomer selected from the group consisting of 4-chloro-4′-hydroxybenzophenone and derivatives of 4-chloro-4′-hydroxybenzophenone;
or reacting at least one monomer selected from the group consisting of 4,4′-difluorobenzophenone and derivatives of 4,4′-difluorobenzophenone with at least one monomer selected from the group consisting of 4,4′-dihydroxybenzophenone and its derivatives to obtain a copolymer of PEK having a molecular weight in the range of 2,000 to 20,000 Daltons; and
c. reacting said copolymer of PEEK with said copolymer of PEK to obtain the PEEK/PEK block copolymer having a molecular weight in the range of 30,000 to 2,00,000 Daltons;
Sequence II.
(a) reacting at least one monomer selected from the group consisting of biphenol and derivatives of biphenol with at least one monomer selected from the group consisting of 4,4′-difluorobenzophenone and derivatives of 4,4′-difluorobenzophenone; or reacting at least one monomer selected from the group consisting of biphenol and derivatives of biphenol, at least one monomer selected from the group consisting of hydroquinone and derivatives of hydroquinone with at least one monomer selected from the group consisting of 4,4′-difluorobenzophenone and derivatives of 4,4′-difluorobenzophenone to obtain a copolymer of PEEK having a molecular weight in the range of 2,000 to 20,000 Daltons; and
(b) reacting at least one monomer selected from the group consisting of 4-chloro-4′-hydroxybenzophenone and derivatives of 4-chloro-4′-hydroxybenzophenone with said copolymer of PEEK to obtain the PEEK/PEK block copolymer having a molecular weight in the range of 30,000 to 2,00,000 Daltons; and
Sequence III
(a) condensing at least one monomer selected from the group consisting of 4-chloro-4′-hydroxybenzophenone and derivatives of 4-chloro-4′-hydroxybenzophenone; or reacting at least one monomer selected from the group consisting of 4,4′-difluorobenzophenone and derivatives of 4,4′-difluorobenzophenone with at least one monomer selected from the group consisting of 4,4′-dihydroxybenzophenone and its derivatives to obtain a copolymer of PEK having a molecular weight in the range of 2,000 to 20,000 Daltons; and
(b) reacting, at least one monomer selected from the group consisting of biphenol with at least one monomer selected from the group consisting of 4,4′-difluorobenzophenone, or at least one monomer selected from the group consisting of biphenol and derivatives of biphenol, at least one monomer selected from the group consisting of hydroquinone and derivatives of hydroquinone with at least one monomer selected from the group consisting of 4,4′-difluorobenzophenone and derivatives of 4,4′-difluorobenzophenone with said copolymer of PEK to obtain the PEEK/PEK block copolymer having a molecular weight in the range of 30,000 to 2,00,000.

20. A process for preparing PEEK/PEK random copolymer, said process comprising adopting any one of the following methods:
I. reacting at least one monomer selected from the group consisting of biphenol and derivatives of biphenol, at least one monomer selected from the group consisting of 4,4′-difluorobenzophenone and derivatives of 4,4′-difluorobenzophenone and at least one monomer selected from the group consisting of 4-chloro-4′-hydroxybenzophenone and derivatives of 4-chloro-4′-hydroxybenzophenone; or
II. reacting at least one monomer selected from the group consisting of biphenol and derivatives of biphenol, at least one monomer selected from the group consisting of hydroquinone and derivatives of hydroquinone, at least one monomer selected from the group consisting of 4,4′-difluorobenzophenone and derivatives of 4,4′-difluorobenzophenone and at least one monomer selected from the group consisting of 4-chloro-4′-hydroxybenzophenone and derivatives of 4-chloro-4′-hydroxybenzophenone; or
III. reacting at least one monomer selected from the group consisting of biphenol and derivatives of biphenol, at least one monomer selected from the group consisting of 4,4′-difluorobenzophenone and derivatives of 4,4′-difluorobenzophenone and at least one monomer selected from the group consisting of 4,4′-dihydroxybenzophenone and its derivatives; and
IV. reacting at least one monomer selected from the group consisting of biphenol and derivatives of biphenol, at least one monomer selected from the group consisting of hydroquinone and derivatives of hydroquinone, at least one monomer selected from the group consisting of 4,4′-difluorobenzophenone and derivatives of 4,4′-difluorobenzophenone and at least one monomer selected from the group consisting of 4,4′-dihydroxybenzophenone and its derivatives,
to obtain the PEEK/PEK random copolymer having a molecular weight in the range of 30,000 to 2,00,000.
